(19) United States
(12) Patent Application Publication
(10) Pub. No.: US 2024/0180163 A1
(43) Pub. Date: Jun. 6, 2024

(54) COMPOSITION FOR PROMOTING PLANTS GROWTH AND/OR FOR PROTECTING PLANTS AGAINST AT LEAST ONE PLANT PEST AND/OR ONE PLANT DISEASE

(71) Applicants: UNIVERSITE DE LIEGE, Liège (BE); UNIVERSITE DE LILLE, Lille (FR)

(72) Inventors: Barbara FIFANI, Gembloux (BE); Philippe JACQUES, Gembloux (BE); Frank DELVIGNE, Gembloux (BE); Vincent PHALIP, Villeneuve d'Ascq (FR)

(21) Appl. No.: 18/285,314

(22) PCT Filed: Apr. 4, 2022
(86) PCT No.: PCT/EP2022/058908

§ 371 Date: Oct. 2, 2023

(30) Foreign Application Priority Data
Apr. 2, 2021 (EP) 21166842.1

(51) Int. Cl. A01N 63/22; A01N 37/44; A01N 63/38; A01P 1/00; A01P 3/00; A01P 5/00; A01P 7/04; A01P 15/00; A01P 21/00; C05C 5/02

(52) U.S. Cl. CPC A01N 63/22; A01N 37/44; A01N 63/38; A01P 1/00; A01P 3/00; A01P 5/00; A01P 7/04; A01P 15/00; A01P 21/00; C05C 5/02

(57) ABSTRACT

The present disclosure relates to a composition for promoting plants growth and/or for protecting plants against at least one plant pest and/or one plant disease, the composition comprising simultaneously at least one bacteria of the genus Bacillus producing antifungal lipopeptides, at least one fungi of the genus Trichoderma, and at least one nitrogen mineral source. The present disclosure also relates to the use of such a composition and to a method for obtaining such a composition. The present disclosure also relates to a co-culture medium for producing at least in part such a composition.

### CROSS-REFERENCE TO RELATED APPLICATION(S)

This present application is a national stage application of International Patent Application No. PCT/EP2022/058908, filed Apr. 4, 2022, which claims priority to European Patent Application No. 21166842.1, filed Apr. 2, 2021, the disclosures of which are hereby incorporated by reference in their entireties.

### FIELD OF THE INVENTION

The present disclosure relates to a composition for promoting plants growth and/or for protecting plants against at least one plant pest and/or one plant disease. The present disclosure also relates to the use of such a composition and to a method for obtaining such a composition. The present disclosure also relates to a co-culture medium for producing at least in part such a composition.

### BACKGROUND OF THE INVENTION

Over the last decades, co-culture strategies of different microorganisms, belonging or not to the same kingdom (e.g., bacteria-bacteria or bacteria-fungus co-culture), drew the attention of a lot of microbiologists. This field is basically explored for its attractive results emerging on the level of induction of production of natural secondary metabolites by the co-cultivated strains. Nonetheless, other interesting traits of the co-culture are studied, such as the nutritional dependence and cross-feeding.

Metabolic cross-feeding refers to the process where one strain is capable to use a molecule produced by the metabolism of another strain as a nutrient source. As for nutritional dependence, the cross-feeding is crucial for the growth of the concerned strain. For instance, in the case of rumen bacteria, the growth of the amino acid-dependent bacteria is impossible before its production by the bacteria capable of using the available substrates. In this regard, the uncultivability of 99% of all bacteria and archaea in laboratory conditions must in part be due to the dependence of the microorganism on nutrients or growth factors provided by others in their natural habitats.

In fact, according to a metabolic model established with 800 microbial community (Zelezniak et al. 2015. Metabolic dependencies drive species co-occurrence in diverse microbial communities. PNAS. 112 (20), 6449-6454), all of them enclose metabolically-dependent groups that swap sugars, amino acids and other metabolites. To understand and to explore their implication, this kind of nutritional interactions can be enforced through in-vitro studies either by genetic engineering where a gene deletion can generate an auxotroph strain or basically by using a culture medium lacking an essential nutrient for the growth of one of the co-cultivated species.

Bacillus and Trichoderma are genera involved in the protection of plants and thereof called biocontrol agents (BCA). The latter has become of great interest for researchers looking forward to developing environmental-friendly solutions to prevent and treat plants disease caused by biotic and abiotic factors. Bacillus and Trichoderma are usually found in plants rhizosphere and they were shown to have an antagonist effect against many plant pathogens especially fungi. Some pathogens are found to be inhibited by both Trichoderma and Bacillus. Other inhibitions are limited to one genera of biocontrol agent. For instance, the growth of Botrytis and Fusarium species can be suppressed by the action of Trichoderma or Bacillus (Coninck et al. 2020. Trichoderma atroviride as a promising biocontrol agent in seed coating for reducing Fusarium damping-off on maize. J Appl Microbiol. 129 (3), 637-651; Vos et al. 2015. The toolbox of Trichoderma spp. in the biocontrol of Botrytis cinerea disease. Mol Plant Pathol. 16 (4), 400-412; Khan et al. 2018. Antifungal Activity of Bacillus Species Against Fusarium and Analysis of the Potential Mechanisms Used in Biocontrol. Front Microbiol. 2 (9), 2363; Toral et al. 2020. Crop Protection against Botrytis cinerea by Rhizhosphere Biological Control Agent Bacillus velezensis XT1. Microorganisms. 8 (7), 992). However, the antifungal activity of Bacillus but not of Trichoderma was demonstrated against Monilinia (Zhou et al. 2019. Bacillus subtilis CF-3 Volatile Organic Compounds Inhibit Monilinia fructicola Growth in Peach Fruit. Front Microbiol. 7 (10), 1804). In contrast, among these two biocontrol agents, only Trichoderma is efficient against Phaeoacremonium minimum, responsible of the petri disease of grapevines (Carro-Huerga et al. 2020. Colonization of Vitis vinifera L. by the Endophyte Trichoderma sp. Strain T154: Biocontrol Activity Against Phaeoacremonium minimum. Front Plant Sci. 4 (11), 1170).

Regarding the mode of action of Trichoderma (mycoparasitism, antibiosis and induction of plant systemic resistance) and its advantages (abiotic stress tolerance, high growth rate . . . ) as a BCA, they are well described by Adnan et al. (Adnan et al. 2019. Plant defense against fungal pathogens by antagonistic fungi with Trichoderma in focus. Microbial Pathogenesis, 129, 7-8).

On its side, Bacillus is well known for its high genetic capacity to produce antimicrobial molecules, especially cyclic lipopeptides (Ongena et al. 2008. Bacillus lipopeptides: versatile weapons for plant disease biocontrol. Trends Microbiol 16:115-125). Among them, surfactin, fengycin, and iturin are the main produced families. Some isoforms of the lipopeptides, belonging to the fengycin and iturin families, have already been described to own anti-microbial activities that can explain the biocontrol behavior of Bacillus strains (Romano et al. 2013. Antifungal cyclic lipopeptides from Bacillus amyloliquefaciens strain BO5A. Journal of Natural Products, 76 (11), 2019-2025; Kupper et al. 2020. Production of antifungal compounds by Bacillus spp. isolates and its capacity for controlling citrus black spot under field conditions. World Journal of Microbiology Biotechnology, 36 (1), 1-10).

Bacillus and Trichoderma are species also involved in plant growth as highlighted by several studies (Bononi et al. 2020. Phosphorus-solubilizing Trichoderma spp. from Amazon soils improve soybean plant growth. Scientific Reports, 10 (2858), 1-13; Chen et al. 2019. Antimicrobial, plant growth-promoting and genomic properties of the peanut endophyte Bacillus velezensis LDO2. Microbiological Research, 218, 41-48; Giridhar et al. 2019. Characterization of Trichoderma asperellum RM-28 for its sodicsaline-alkali tolerance and plant growth promoting activities to alleviate toxicity of red mud. Science of The Total Environment, 662, 462-469; Saechow et al. 2018. Antagonistic Activity against Dirty Panicle Rice Fungal Pathogens and Plant Growth-Promoting Activity of Bacillus amyloliquefaciens BAS23. Journal of Microbiology and Biotechnology, 28 (9), 1527-1535).

It appears to be of high interest to combine Bacillus and Trichoderma species for the biocontrol of pathogens, especially for the biocontrol of fungal pathogens. The different modes of action of these beneficial microorganisms, as well as the broad spectrum of pathogens on which they are commonly or singularly active, could enhance their efficiency in comparison to the single use of one of them.

In view of the above, it is of interest to co-culture Bacillus producing antifungal lipopeptides and Trichoderma species as BCAs for obtaining better biocontrol effects and growth promotion of plants, in particular for obtaining a composition comprising Bacillus producing antifungal lipopeptides and Trichoderma species as BCAs growing and developing simultaneously and preferably concomitantly in the same culture medium.

More particularly, it is of interest to co-culture Bacillus producing antifungal lipopeptides and Trichoderma species as BCAs for promoting plants growth and/or for protecting plants against at least one plant pest and/or one plant disease, in particular for obtaining a composition comprising Bacillus producing antifungal lipopeptides and Trichoderma species as BCAs for promoting plants growth and/or for protecting plants against at least one plant pest and/or one plant disease.

Even more particularly, it is of interest to co-culture Bacillus producing antifungal lipopeptides and Trichoderma species as BCAs for controlling diseases notably caused by plant pests such as fungi, oomycetes, bacteria, viruses, nematodes and insects, in particular for obtaining a composition comprising Bacillus producing antifungal lipopeptides and Trichoderma species as BCAs for controlling diseases notably caused by plant pests such as fungi, oomycetes, bacteria, viruses, nematodes and insects.

Unfortunately, nowadays, co-cultures of Bacillus producing antifungal lipopeptides and Trichoderma species are certainly not efficient and optimal. Indeed, the antifungal lipopeptides such as surfactin, fengycin and iturin produced by bacteria of the genus Bacillus inhibit the growth and development of fungi, in particular the growth and development of fungi of the genus Trichoderma. Consequently, the current co-cultures of Bacillus producing antifungal lipopeptides and Trichoderma species are not efficient and optimal, the Bacillus species preventing the Trichoderma species to grow and to develop adequately. For the same reasons, the current compositions comprising Bacillus producing antifungal lipopeptides and Trichoderma species are not efficient and optimal to guarantee simultaneously and preferably concomitantly the growth of bacteria of the genus Bacillus producing antifungal lipopeptides and the growth of Trichoderma species in co-cultures for use as biocontrol agents (BCA) or as promotors for plants growth.

### SUMMARY OF THE INVENTION

It is an object of the disclosure to overcome at least partly the abovementioned drawbacks and to provide a composition for promoting plants growth and/or for protecting plants against at least one plant pest and/or one plant disease. It is also an object of the disclosure to provide a composition suitable for promoting plants growth and/or for protecting plants against at least one plant pest and/or one plant disease.

In particular, it is an object of the disclosure to co-culture Bacillus producing antifungal lipopeptides and Trichoderma species as BCAs for obtaining better biocontrol effects and better growth promotion of plants, in particular for obtaining a composition comprising Bacillus producing antifungal lipopeptides and Trichoderma species as BCAs growing and developing simultaneously and preferably concomitantly in the same culture medium.

More particularly, it is an object of the disclosure to co-culture Bacillus producing antifungal lipopeptides and Trichoderma species as BCAs for promoting plants growth and/or for protecting plants against at least one plant pest and/or one plant disease, in particular for obtaining a composition comprising Bacillus producing antifungal lipopeptides and Trichoderma species as BCAs for promoting plants growth and/or for protecting plants against at least one plant pest and/or one plant disease.

Even more particularly, it is an object of the disclosure to co-culture Bacillus producing antifungal lipopeptides and Trichoderma species as BCAs for controlling diseases notably caused by plant pests such as fungi, oomycetes, bacteria, viruses, nematodes and insects, in particular for obtaining a composition comprising Bacillus producing antifungal lipopeptides and Trichoderma species as BCAs for controlling diseases notably caused by plant pests such as fungi, oomycetes, bacteria, viruses, nematodes and insects.

To this end, according to the disclosure, there is provided a composition for promoting plants growth and/or for protecting plants against at least one plant pest and/or one plant disease, said composition comprising simultaneously at least one bacteria of the genus Bacillus producing antifungal lipopeptides, at least one fungus of the genus Trichoderma, and at least one nitrogen mineral source.

Preferably, according to the disclosure, the composition predominantly comprises at least one nitrogen mineral source as a nitrogen source. This means that, advantageously, the composition according to the disclosure comprises proportionally more mineral nitrogen if both a nitrogen mineral source and a nitrogen organic source are present in the composition.

More preferably, according to the disclosure, the composition only comprises at least one nitrogen mineral source as a nitrogen source. This means that, advantageously, the composition according to the disclosure does not comprise an organic nitrogen source in addition to said at least one nitrogen mineral source. In other words, this means that, advantageously, the composition according to the disclosure comprises mineral nitrogen as the unique source of nitrogen.

In the context of the present disclosure, based on the FAO definition of “pest” in terms of the International Plant Protection Convention and phytosanitary measures worldwide (FAO, 1990; revised FAO, 1995; IPPC, 1997), the terms “plant pests” mean any species, strain or biotype of plant, animal, or pathogenic agent injurious to plants, for example fungi, oomycetes, bacteria, viruses, viroids, virus-like organisms, phytoplasmas, protists, protozoa, nematodes, insects and parasitic plants. In this sense, the terms “plant pests” include all plant pathogens, i.e. all biological organisms that can cause disease symptoms and/or plant diseases and/or significantly reduce the productivity, quality, and even cause the death of plants.

In the context of the present disclosure, the terms “plant diseases” mean anything that prevents a plant from performing to its maximum potential, notably in terms of development and productivity.

In the context of the present disclosure, the terms “for protecting plants” refer to mechanisms or to the activation of mechanisms (for example the activation of systemic resistance in plants) aimed at controlling or reducing the pests and/or to minimize their effects on the plant. Plant protection can be for example achieved by killing the pests, by delaying their growth and/or reproduction or by reducing sporulation.

In the context of the present disclosure, the terms “for promoting plants growth” refer to the activation/reinforcement of mechanisms aimed at ensuring plants growth, notably under water stress conditions.

In the context of the present disclosure, the terms “nitrogen mineral source” mean any compound/molecule comprising nitrogen and being from mineral origin and not from organic origin.

In the context of the present disclosure, the terms “antifungal lipopeptides” mean secondary metabolites, in particular secondary metabolites composed of amino acids and fatty acid chains produced by non-ribosomal pathways, having antifungal activity, meaning it can inhibit the growth and propagation of fungi.

In the context of the present disclosure, it was surprisingly determined that a composition according to the disclosure comprising at least one nitrogen mineral source allows both at least one bacteria of the genus Bacillus producing antifungal lipopeptides and at least one fungus of the genus Trichoderma to coexist, to grow and to develop simultaneously and preferably concomitantly in co-culture in the same medium.

This simultaneous and preferably concomitant growth and development in co-culture in the same medium of a bacteria of the genus Bacillus producing antifungal lipopeptides and of a fungus of the genus Trichoderma was totally unexpected since the bacteria naturally produces antifungal lipopeptides (in particular surfactin, fengycin and iturin) preventing the growth and development of fungi, notably the growth and development of fungi of the genus Trichoderma. Also, unexpectedly and in the context of the present disclosure, it was highlighted that fungi of the genus Trichoderma promote and regulate the growth of bacteria of the genus Bacillus producing antifungal lipopeptides. In particular, against all expectation, it was highlighted that the production of antifungal lipopeptides by bacteria of the genus Bacillus is inhibited by fungi of the genus Trichoderma in co-cultures, i.e. in a composition according to the present disclosure comprising simultaneously at least one bacteria of the genus Bacillus producing antifungal lipopeptides, at least one fungus of the genus Trichoderma, and at least one nitrogen mineral source.

In the context of the present disclosure, it was shown that a composition according to the disclosure comprising at least one nitrogen mineral source promotes roots production and consequently the plant growth. It was also shown that a composition according to the disclosure comprising at least one nitrogen mineral source improves germination of seeds and consequently the plant growth, in particular under water stress conditions.

The disclosure is defined by the independent claims. The dependent claims define advantageous embodiments.

Preferably, according to the disclosure, said at least one nitrogen mineral source is chosen in the group comprising of nitrates, nitrites, and mixtures thereof.

Advantageously, according to the disclosure, said nitrates are chosen in the group comprising sodium nitrate, calcium nitrate, potassium nitrate, and mixtures thereof.

Preferably, according to the disclosure, said nitrites are chosen in the group comprising sodium nitrite, calcium nitrite, potassium nitrite, and mixtures thereof.

Preferably, according to the disclosure, in particular when the composition is under a liquid form, said at least one nitrogen mineral source, in particular said nitrate(s) and/or nitrite(s), is/are present in the composition at a concentration ranging from 1 mM to 1 M, preferably ranging from 50 mM to 100 mM, more preferably at a concentration of 70 mM.

Eventually, if the composition according to the disclosure is under the form of a concentrate composition, said at least one nitrogen mineral source, in particular said nitrate(s) and/or nitrite(s), is/are present in the composition at a concentration ranging from 0.05 M to 135 M, preferably at a concentration of 1 M.

Advantageously, according to the disclosure, said at least one bacteria of the genus Bacillus is present in the composition at a concentration ranging from 2·10³ cells·g⁻¹ to 2·10⁶ cells·g⁻¹, preferably at a concentration of 2·10⁴ cells·g⁻¹.

Eventually, if the composition according to the disclosure is under the form of a concentrate composition, said at least one bacteria of the genus Bacillus is present in the composition at a concentration ranging from 2·10⁷ cells·g⁻¹ to 2·10¹¹ cells·g⁻¹, preferably at a concentration of 2·10⁹ cells·g⁻¹.

Preferably, according to the disclosure, said at least one fungus of the genus Trichoderma is present in the composition at a concentration ranging from 2.10⁴ spore·g⁻¹ to 2·10⁷ spore·g⁻¹, preferably at a concentration of 2·10⁵ spore·g⁻¹.

Eventually, if the composition according to the disclosure is under the form of a concentrate composition, said at least one fungus of the genus Trichoderma is present in the composition at a concentration ranging from 2·10⁸ spore·g⁻¹ to 2·10¹¹ spore·g⁻¹, preferably at a concentration of 5·10⁹ spore·g⁻¹

Advantageously, according to the disclosure, said at least one bacteria of the genus Bacillus producing antifungal lipopeptides and said at least one fungus of the genus Trichoderma are present in the composition in a cellular concentration ratio 1:2, preferably in a ratio 1:5, more preferably in a ratio 1:10.

In the sense of the present disclosure, the term “cellular” designates cell(s) but also spore(s).

Preferably, according to the disclosure, said at least one nitrogen mineral source, in particular said nitrate(s) and/or nitrite(s), is/are present in the composition in the range of 0.5% to 70% by weight relative to the total weight of the composition, preferably at 10% by weight relative to the total weight of the composition.

Advantageously, according to the disclosure, said at least one bacteria of the genus Bacillus is present in the composition in the range of 0.01% to 2% by weight relative to the total weight of the composition, preferably at 0.1% by weight relative to the total weight of the composition.

Preferably, according to the disclosure, said at least one fungus of the genus Trichoderma is present in the composition in the range of 0.2% to 25% by weight relative to the total weight of the composition, preferably at 2% by weight relative to the total weight of the composition.

Advantageously, according to the disclosure, said at least one bacteria of the genus Bacillus producing antifungal lipopeptides is chosen in the group comprising Bacillus subtilis, Bacillus amyloliquefaciens, Bacillus circulans, Bacillus thuringiensis, Bacillus pumilus, Bacillus vallismortis, Bacillus licheniformis, Bacillus mojavensis, Bacillus velezensis, Bacillus haynesii, Bacillus paralicheniformis, Bacillus sonorensis, Bacillus glycinifermentans, and mixtures thereof. This list is not exhaustive.

Advantageously, according to the disclosure, said at least one fungus of the genus Trichoderma is chosen in the group comprising Trichoderma harzianum, Trichoderma atrobrunneum, Trichoderma asperellum, Trichoderma virens, Trichoderma atroviride, Trichoderma erinaceum, Trichoderma longibrachiatum, and mixtures thereof. This list is not exhaustive.

Preferably, according to the disclosure, the composition is under the form of granules, tablets, powders, liquids, (micro-) emulsions, nano-formulations, (micro-) encapsulates, (water-soluble) concentrates, (concentrated) suspensions, (concentrated) dispersions, wettable granulates and powders or aerosols. This list is not exhaustive.

Eventually, the composition according to the disclosure further comprises a solvent and/or a co-formulant selected from the group comprising detergents, emulsifiers, dispersing agents, anti-foaming agents, penetration enhancers, humectants, ionic or non-ionic wetting agents, anti-freeze agents, preservative agents such as antioxidants (for example carotenoids and/or polyphenols and/or vitamin E), absorbent agents, thickeners, buffers, sticker agents, diluents, and mixtures thereof, preferably a surfactant selected from the group comprising: detergents, emulsifiers, dispersing agents, anti-foaming agents, penetration enhancers, humectants or ionic or non-ionic wetting agents, and mixtures thereof. This list is not exhaustive.

Indeed, the composition according to the disclosure can contain additional components, such as co-formulants, to obtain a product with good handling, efficacy and stability properties. According to the disclosure, the term “co-formulant” designates any substance other than nitrogen mineral source(s), bacteria of the genus Bacillus producing antifungal lipopeptides and/or fungus of the genus Trichoderma.

The composition according to the disclosure can comprise a surfactant, i.e. a compound that lowers the surface tension of a liquid, allowing easier spreading. The surfactant can be a detergent, an emulsifier (including alkyl polyglucosides glycerol ester or polyoxyethylene (20) sorbitan monolaurate), a dispersing agent (including sodium chloride, potassium chloride, potassium nitrate, calcium chloride or starch of corn), a foaming agent (including derivates of tartric acid, malic acid or alcohols), a penetration enhancer, a humectant (including ammonium sulfate, glycerin or urea) or a wetting agent of ionic or non-ionic type or a mixture of such surfactants.

The terms “penetration enhancer” mean a compound that accelerates the uptake of active ingredient through the cuticle of a plant into the plant, i.e. the rate of uptake, and/or increases the amount of active ingredient absorbed into the plant. Classes of substances known as penetration enhancers, include alkyl phosphates, such as tributyl phosphate and tripropyl phosphate, and naphthalenesulphonic acid salts.

The terms “dispersing agent” mean a substance added to a suspension, usually a colloid, to improve the separation of particles and to prevent settling or clumping.

The term “emulsifier” means a substance that stabilizes an emulsion, i.e. a mixture of two or more liquids. Mention can be made of the emulsifier sold under the trade names Tween® 20, which essentially comprises polyoxyethylene (20) sorbitan monolaurate (polysorbate 20).

Eventually, the composition according to the disclosure can comprise one or more other active compounds/or substances selected from the group comprising herbicides, insecticides, plant growth regulators or plant immune system elicitors, and mixtures thereof.

Preferably, the composition according to the disclosure is from natural, synthetic, or biosynthetic origin. More specifically, said at least one nitrogen mineral source is from natural, synthetic, or biosynthetic origin.

The present disclosure is also about a method for obtaining a composition according to the disclosure, said method comprising:
forming a co-culture medium, in particular a liquid co-culture medium, comprising at least one nitrogen mineral source, for example nitrates and/or nitrites, in particular nitrates and/or nitrites chosen in the group comprising sodium nitrate, calcium nitrate, potassium nitrate, sodium nitrite, calcium nitrite, potassium nitrite, and mixtures thereof; and
adding to said co-culture medium at least one bacteria of the genus Bacillus producing antifungal lipopeptides and at least one fungus of the genus Trichoderma, for example lyophilised or dried cells of at least one bacteria of the genus Bacillus producing antifungal lipopeptides and lyophilised or dried spores of at least one fungus of the genus Trichoderma.

For example, lyophilisation, spray drying, freeze-drying or fluidisation may be used for obtaining lyophilised or dried cells or spores.

Preferably, the method according to the disclosure further comprises an incubation step of the co-culture medium after the addition to said co-culture medium of said at least one bacteria of the genus Bacillus producing antifungal lipopeptides and of said at least one fungus of the genus Trichoderma.

In a first embodiment according to the disclosure, the steps of forming a co-culture medium and of adding to said co-culture medium at least one bacteria of the genus Bacillus producing antifungal lipopeptides and at least one fungus of the genus Trichoderma are performed simultaneously and preferably concomitantly.

In a second embodiment according to the disclosure, the steps of forming a co-culture medium and of adding to said co-culture medium at least one bacteria of the genus Bacillus producing antifungal lipopeptides and at least one fungus of the genus Trichoderma are performed sequentially.

Eventually, according to another embodiment according to the disclosure, said least one bacteria of the genus Bacillus producing antifungal lipopeptides and said at least one fungus of the genus Trichoderma are added to the co-culture medium sequentially, in particular before incubation of the co-culture.

Preferably, said at least one bacteria of the genus Bacillus producing antifungal lipopeptides is added to the co-culture medium at the latest before a growth of said at least one fungus of the genus Trichoderma previously added to said co-culture medium.

More preferably, said at least one bacteria of the genus Bacillus producing antifungal lipopeptides is added to the co-culture medium within 2 hours after a previous addition of said at least one fungus of the genus Trichoderma to the co-culture medium, in particular before incubation of the co-culture.

Advantageously, according to the disclosure, the incubation of the co-culture is started only once both said least one bacteria of the genus Bacillus producing antifungal lipopeptides and said at least one fungus of the genus Trichoderma are present into said co-culture medium.

The present disclosure is also about the use of a composition according to the disclosure to protect plants against at least one plant pest and/or plant disease and/or to promote plants growth, in particular in agricultural and horticultural applications.

For example, a composition according to the disclosure can protect plants against at least one plant pest and/or plant disease by acting as an elicitor, meaning that a composition according to the disclosure can act as an inducer of the plant immune system stimulating defense responses in plants against plant pests and plant diseases. Also, a composition according to the disclosure can protect plants against at least one plant pest and/or plant disease by direct action on pathogens (antifungal lipopeptides from Bacillus, mycoparasitism and/or antibiosis from Trichoderma).

Preferably, when used, the composition according to the disclosure is applied before harvest or post-harvest to the whole plant, the rhizosphere, the roots, the leaves, the flowers, fruits, seeds, seedlings or seedlings pricking out, propagation material such as tubers or rhizomes, and/or to the soil or inert substrate wherein the plant is growing or in which it is desired to grow, by spraying, drenching, soaking, dipping, injection or administration through fertilizing or irrigation systems.

Advantageously, according to the disclosure, said plant pests are selected from the group comprising fungi, oomycetes, bacteria, viruses, viroids, virus-like organisms, phytoplasmas, protists, protozoa, nematodes, and insects.

Non-limiting examples of phytopathogenic fungi and fungal-like organisms that can be targeted by the compositions according to the present disclosure include Pyricularia spp.; Puccinia spp.; Erysiphe spp.; Cochliobolus spp.; Helminthosporium spp.; Drechslera spp.; Rhynchosporium spp.; Cercospora spp.; Botrytis spp.; Alternaria spp.; Venturia spp.; Cladosporium spp.; Monilinia spp.; Didymella spp.; Phoma spp.; Aspergillus spp.; Aureobasidium spp.; Ascochyta spp.; Stemphylium spp.; Pleospora spp.; Peronospora spp.; Pythium spp.; Phytophthora spp.; Rhizoctonia spp.; Sclerotinia spp.; Sclerotium spp.; Colletotrichum spp.; Mycosphaerella spp.; Diaporthe spp.; Elsinoe spp.; Verticillium spp.; Pyrenopeziza spp.; Fusarium spp.; Typhula spp.; Ustilago spp.; Urocystis spp.; Tilletia spp.; Ramularia spp.; Penicillium spp.; Acremoniella spp.; Allomyces spp.; Amorphothec spp.; Aspergillius spp.; Blastocladiella spp.; Candida spp.; Chaetomium spp.; Coccidioides spp.; Conidiobolus spp.; Coprinopsis spp.; Corynascus spp.; Cryphonectria spp., Cryptococcus spp.; Cunninghamella spp.; Curvularia spp.; Debarymyces spp.; Diplodia spp; Emericella ssp.; Encephalitozoon spp.; Eremothecium spp.; Gaeumanomyces spp.; Geomyces spp.; Gibberella spp.; Gloeophyllum spp.; Glomus spp.; Hypocrea spp.; Kluyveromyces spp.; Lentinula spp.; Leucosporidium spp.; Macrophomina spp.; Magnaportha spp.; Metharhizium spp.; Mucor spp.; Neurospora spp.; Nectria spp.; Paracocidioides spp.; Phaeopsheria spp.; Phanerochaete spp.; Phakopsora spp.; Phymatotrichum spp.; Pneumocystis spp.; Pyronema spp.; Rhizoctonia spp.; Rhizopus spp.; Saccharomyces spp.; Scerotium spp.; Spizellomyces spp.; Thermomyces spp.; Thielaviopsis spp.; Trametes spp.; Trichophyton spp.; Yarrowia spp.; Trichoderma agressivum; Phomopsis spp.; Botryosphaeria spp.; Eutypa spp.; Fomitiporia spp.; Phaeoacremonium spp.; Phaeomoniella spp.; Fusicladium spp.; Oidium spp.; Podosphaera spp.; Microsphaera spp.; Golonivomyces spp.; Leveillula spp.; Phyllactinia spp.; Brasiliomyces spp.; Sphaerotheca spp.; Blumeria spp.; or Neoerysiphe spp. In particular, phytopathogenic fungi and fungal-like organisms that can be targeted by the compositions according to the present disclosure are Botrytis cinerea, Fusarium oxysporum, Sclerotinia sclerotiorum, Rhizoctonia a solani, Pythium aphanidermatum, Eutypa lata, Botryosphaeria sp., Fomitiporia sp., Phaeoacremonium sp., or Phaeomoniella sp.

Plant diseases caused by fungi that can be targeted by the compositions according to the present disclosure include notably yeasts, rusts, smuts, mildews, molds, mushrooms and toadstools.

Non-limiting examples of phytopathogenic bacteria that can be targeted by the compositions according to the present disclosure include the genera Erwinia, Pseudomonas, Xanthomonas, Ralstonia, and Xylella.

Non-limiting examples of phytopathogenic viruses that can be targeted by the compositions according to the present disclosure include Cucumber Mosaic Virus, Barley Yellow Mosaic Virus, Strawberry Mild Yellow Edge Virus, Strawberry Latent Ringspot Virus, Beet Necrotic Yellow Vein Virus and Potato Virus Y.

Non-limiting examples of phytopathogenic insects that can be targeted by the compositions according to the present disclosure include notably aphids, beetles, bugs, hoppers, locusts, mites, ants, ticks, trips, whiteflies, rootworms, maggots, weevils, (stem)borers, caterpillars, butterflies, leaf-rolers, and leaf-miners.

The present disclosure is also about a method for promoting plants growth and/or for protecting plants against at least one plant pest and/or one plant disease, the method comprising:
applying an effective and substantially non-phytotoxic amount of the composition according to the disclosure to at least one of a part of a plant; and
obtaining protection of said plant against at least one plant pest and/or plant disease, in particular against at least one plant pest selected from the group comprising fungi, oomycetes, bacteria, viruses, viroids, virus-like organisms, phytoplasmas, protists, protozoa, nematodes, insects and parasitic plants and/or obtaining growth promotion of said plant.

In the context of the present disclosure, the terms “effective and non-phytotoxic amount” mean an amount of the composition according to the present disclosure that is sufficient to control or destroy and/or to induce control or destruction of the plant pests present or liable to appear on the plants, and that does not have a phytotoxicity impact for said plants and/or an amount of the composition according to the present disclosure promoting growth of plant.

Preferably, the method according to the disclosure allows obtaining protection of plants against plant pests selected from the group comprising fungi, oomycetes, bacteria, viruses, viroids, virus-like organisms, phytoplasmas, protists, protozoa, nematodes, and insects.

Advantageously, according to the disclosure, the composition is applied before harvest or post-harvest to the whole plant, the rhizosphere, the roots, the leaves, the flowers, fruits, seeds, seedlings or seedlings pricking out, propagation material such as tubers or rhizomes, and/or to the soil or inert substrate wherein the plant is growing or in which it is desired to grow, by spraying, drenching, soaking, dipping, injection or administration through fertilizing or irrigation systems.

The composition according to the disclosure can be ready to be applied to the plant by means of a suitable device, such as a spraying device, or can be the commercial concentrated compositions which have to be diluted before application to the plant.

The present disclosure is also about a co-culture medium for producing at least in part a composition according to the disclosure comprising simultaneously at least one bacteria of the genus Bacillus producing antifungal lipopeptides, and at least one fungus of the genus Trichoderma, said co-culture medium comprising at least one nitrogen mineral source.

Preferably, in a co-culture medium according to the disclosure, said at least one nitrogen mineral source is chosen in the group comprising nitrates, nitrites, and mixtures thereof.

Advantageously, according to the disclosure, said nitrates are chosen in the group comprising sodium nitrate, calcium nitrate, potassium nitrate, and mixtures thereof.

Preferably, in a co-culture medium according to the disclosure, said nitrites are chosen in the group comprising sodium nitrite, calcium nitrite, potassium nitrite, and mixtures thereof.

Preferably, according to the disclosure, said at least one nitrogen mineral source, in particular said nitrate(s) and/or nitrite(s), is/are present in the co-culture medium at a concentration ranging from 1 mM to 1 M, preferably ranging from 50 mM to 100 mM, more preferably at a concentration of 70 mM.

### SHORT DESCRIPTION OF THE DRAWINGS

These and further aspects of the disclosure will be explained in greater details by way of examples and with reference to the accompanying figures in which:

FIGS. 1A, B and C show the level of growth (in mg dry matter·1⁻¹) of Bacillus producing antifungal lipopeptides species and the level of growth of Trichoderma species (in mg dry matter·1⁻¹) according to different culture conditions in mono-culture (of the fungus in ‘no bacteria’ condition and of the bacteria in ‘no fungus’ condition) or in co-cultures: in a Minimal Medium comprising casamino acids (casein hydrolysate) as a nitrogen organic source (MM_{casaminoacids}) (FIG. 1A); in a Minimal Medium comprising NaNO₃ as a nitrogen mineral source (MM_{nitratc}) (FIG. 1B); in a Minimal Medium comprising NaNO₂ as a nitrogen mineral source (MMₙᵢₜᵢᵣᵢₜₑ) (FIG. 1C). In the co-cultures conditions (MM_{casaminoacids}, MMₙᵢₜᵣₐₜₑ, MMₙᵢₜᵢᵣᵢₜₑ), for the co-cultures of the different Bacillus species with the same Trichoderma's species, the dry matter of the fungus obtained with the 3 bacteria is expressed as a mean value.

FIG. 2 shows the growth (in mg dry matter·1⁻¹) over time of B. velezensis LMG P-32278 (1) in a composition/in a co-culture medium according to the disclosure comprising NaNO₃ as a nitrogen mineral source and T. harzianum IHEM5437 (MMₙᵢₜᵣₐₜₑ+T. harzianum IHEM5437) and (2) in a composition/in a culture medium only comprising NaNO₃ as a nitrogen mineral source (MMₙᵢₜᵣₐₜₑ)

FIG. 3 shows the UV spectrum generated by UPLC for lipopeptide detection in a composition/in a co-culture medium according to the disclosure comprising NaNO₃ as a nitrogen mineral source (MMₙᵢₜᵣₐₜₑ) and both B. velezensis LMG P-32278 and T. harzianum IHEM5437 (A), compared of B. velezensis LMG P-32278 in MM_{casaminoacids} (B), standards of iturins (C), fengycin (D) and surfactin (E).

FIG. 4 shows the fresh root biomass per tobacco plant as a function of treatment applied («control», «sodium nitrate», «B. velezensis FZB42», «T. harzianum MUCL29707», «B. velezensis FZB42+T. harzianum MUCL29707», «B. velezensis FZB42+T. harzianum MUCL29707+sodium nitrate»). These data were evaluated at 90 days, on 10 plants/treatment (n=10, mean+/−standard deviation). Means marked with an asterisk are significantly different from the control.

FIG. 5A, FIG. 5B, FIG. 5C and FIG. 5D show the effect of different treatments (<control», «sodium nitrate», «B. velezensis FZB42», «T. harzianum MUCL29707», «B. velezensis FZB42+T. harzianum MUCL29707», «B. velezensis FZB42+T. harzianum MUCL29707+sodium nitrate») on the germination kinetics of tomato seeds in the absence of osmotic stress and in presence of a mild, moderate, and high osmotic stress. The values presented are the means of 5 repetitions+/−standard deviation.

### DETAILED DESCRIPTION OF EMBODIMENTS OF THE DISCLOSURE AND EXAMPLES

Several experiments have been performed with the following Bacillus and Trichoderma strains:

### Bacillus Strains

The following strains have been considered: B. velezensis LMG P-32278; B. velezensis FZB42 (commercially available—accessible to the public; ABITEP GmbH, Germany) and B. velezensis LMG P-32279.

All these strains were freezed in 40% of glycerol at −80° C. An overnight preculture in Tryptone-Yeast extract medium (TY) containing 1% (w/v) tryptone, 0.5% yeast extract, 0.5% NaCl is used to inoculate the cultures. Bacteria are recovered and washed 3 times with physiological water by centrifugation and added to cultures to attain a final concentration of 2.10+ cells·ml⁻¹.

### Trichoderma Strains

The following strains have been considered: T. harzianum IHEM 5437; Trichoderma sp. MUCL 58094; T. harzianum MUCL29707 (commercially available—accessible to the public; BCCM Catalogue) and T. atrobrunneum MUCL 58095.

Spores were generated on Potato Dextrose Agar plates (PDA, Merck KGaA, Darmstadt, Germany) after 10 days of incubation at 30° C. and later kept at 4° C. Spores were recovered with physiological water to which 2 drops of Tween20 were added and counted using a Bürker chamber. Spores were inoculated in the cultures to attain a 2·10⁵ spores·ml⁻¹ final concentration.

### 1. Comparative Tests: Growth of Bacillus Producing Antifungal Lipopeptides Species and Growth of Trichoderma Species in Different Compositions/Culture Media

Compositions/co-culture media according to the disclosure have been tested in terms of growth and development of Bacillus producing antifungal lipopeptides species and in terms of growth and development of Trichoderma species.

Experiments were conducted in flasks of 500 ml filled with the following culture media:
with 100 ml of a medium not comprising nitrogen: 7 mM KCl, 11 mM KH₂HPO+, 2 mM MgSO₄, and 1% (w/v) glucose and trace elements (500× stock; 38 mM ZnSO₄, 89 mM H₃BO₃, 12.5 mM MnCl₂, 9 mM FeSO₄, 3.55 mM CoCl₂, 3.2 mM CuSO₄, 3.1 mM Na₂MoO₄, and 87 mM EDTA-NA₂; or
with 100 ml of a medium comprising casamino acids (casein hydrolysate) as a nitrogen organic source: 0.2% (w/v) casein hydrolysate, 7 mM KCl, 11 mM KH₂HPO₄, 2 mM MgSO₄, and 1% (w/v) glucose and trace elements (500× stock; 38 mM ZnSO₄, 89 mM H₃BO₃, 12.5 mM MnCl₂, 9 mM FeSO₄, 3.55 mM CoCl₂, 3.2 mM CuSO₄, 3.1 mM Na₂MoO₄, and 87 mM EDTA-NA₂; or
with 100 ml of Minimal Medium (MM) comprising NaNO₃ as a nitrogen mineral source: 70 mM NaNO₃, 7 mM KCl, 11 mM KH₂HPO₄, 2 mM MgSO₄, and 1% (w/v) glucose and trace elements (500× stock; 38 mM ZnSO₄, 89 mM H₃BO₃, 12.5 mM MnCl₂, 9 mM FeSO₄, 3.55 mM CoCl₂, 3.2 mM CuSO₄, 3.1 mM Na₂MoO₄, and 87 mM EDTA) (composition according to the present disclosure); or
with the same Minimal Medium (MM) comprising 70 mM NaNO₂ as a nitrogen mineral source instead of 70 mM NaNO₃ (composition according to the present disclosure).

Different cultures were performed in triplicates with the inoculation conditions described above (2·10⁵ spores·ml⁻¹ final concentration for Trichoderma and 2·10⁴ cells·ml⁻¹ for Bacillus): culture of several Bacillus strains alone, of several Trichoderma strains alone and co-cultures of different couple of Bacillus and Trichoderma strains added simultaneously/concomitantly in the different tested culture media. Cultures were incubated for 6 days at 30° C. and shacked at a rate of 120 rpm. The media pH is 6.5 and was not controlled during the culture.

The growth rate of Bacillus was measured by following the optical density of the culture at 600 nm with a V-1200 spectrophotometer or a microplate reader (SpectarMax M2e, Molecular Devices, Sigma-Aldrich). In microplate reader, 96-well plates were used and incubated at 30° C. with medium shaking. Cells were also counted by an Accuri C6 flow cytometer (BD Accuri, San Jose CA, USA) for more accuracy. For all measurements, samples were filtered through CA 5 μm membrane (Sartorius Stedim Biotech GmbH, Goettingen, Germany) to eliminate fungal spores and mycelia. The measured OD and cell concentrations were further converted to dry matter following a standard curve determined earlier.

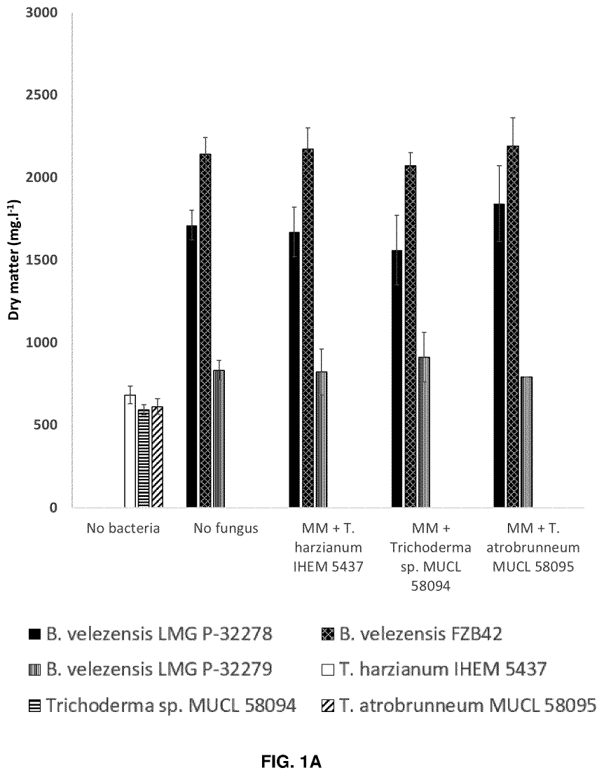

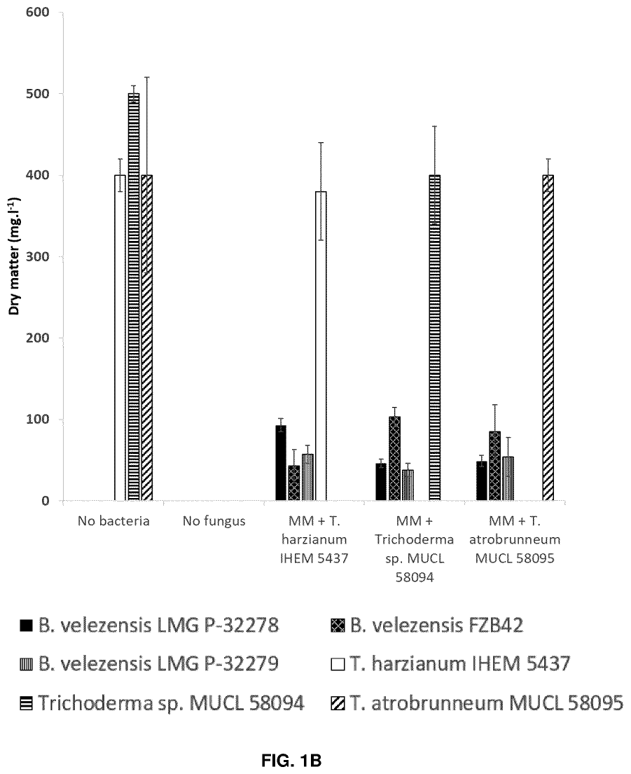

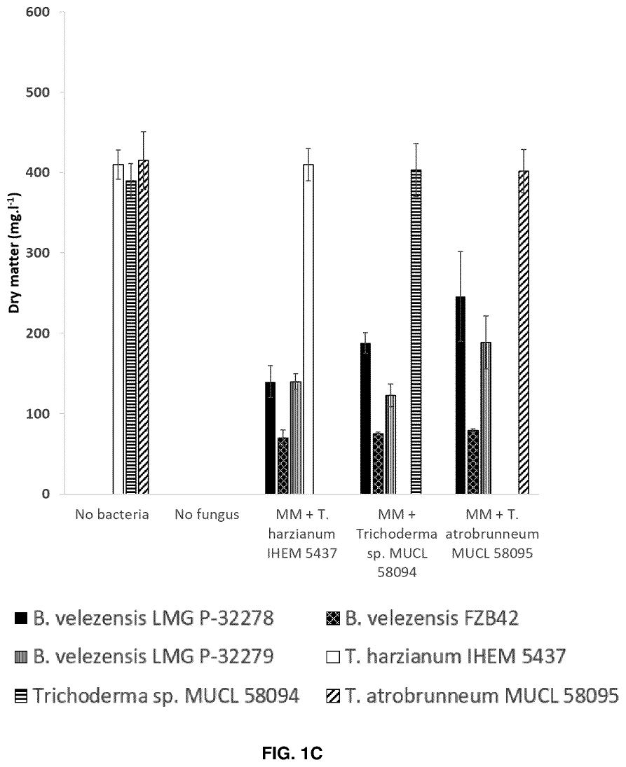

The quantification of Trichoderma was done by measuring the dry matter at the end of the incubation. For that, the biomass was recovered by filtrating the coculture through overlapping layers of gauze with a known weight. The gauze containing fungal biomass was placed in a metallic receptacle which weight was already determined. The receptacle and the biomass were incubated for 24 h at 106° C. The total weight was measured and the difference with the initial weight of the receptacle and gauze was assigned to the dry matter of the fungal biomass. The obtained results are presented in Table 1 and in FIGS. 1A, 1B and 1C.

TABLE 1

| | | | Bacterial growth in line: column culture at day 6 | | | |
|---|---|---|---|---|---|---|
| | | | | T. | Trichoderma | T. |
| | | | | harzianum | sp. MUCL | atrobrunneum |
| | | | No fungus | IHEM 5437 | 58094 | MUCL 58095 |
| MM_{casaminoacids} | Dry matter(mg/l) | No bacteria | — | — | — | — |
| | Standard deviation | | | | | |
| | Dry matter(mg/l) | B. velezensis | 1710 | 1670 | 1560 | 1840 |
| | Standard deviation | LMG P-32276 | 900 | 150 | 210 | 230 |
| | Dry matter(mg/l) | B. velezensis | 2140 | 2170 | 2070 | 2190 |
| | Standard deviation | FZB42 | 100 | 130 | 80 | 170 |
| | Dry matter(mg/l) | B. velezensis | 830 | 820 | 910 | 790 |
| | Standard deviation | LMG P-32279 | 60 | 140 | 150 | 0 |
| MMₙᵢₜᵣₐₜₑ | Dry matter(mg/l) | No bacteria | — | — | — | — |
| | Standard deviation | | | | | |
| | Dry matter(mg/l) | B. velezensis | No growth | 83 | 46 | 49 |
| | Standard deviation | LMG P-32278 | | 8 | 5 | 7 |
| | Dry matter(mg/l) | B. velezensis | No growth | 43 | 103 | 85 |
| | Standard deviation | FZB42 | | 20 | 12 | 33 |
| | Dry matter(mg/l) | B. velezensis | No growth | 57 | 38 | 54 |
| | Standard deviation | LMG P-32279 | | 11 | 8 | 24 |
| MMₙᵢₜᵣₐₜₑ | Dry matter(mg/l) | No bacteria | — | — | — | — |
| | Standard deviation | | | | | |
| | Dry matter(mg/l) | B. velezensis | No growth | 140 | 188 | 246 |
| | Standard deviation | LMG P-32278 | | 20 | 13 | 56 |
| | Dry matter(mg/l) | B. velezensis | No growth | 70 | 75 | 79 |
| | Standard deviation | FZB42 | | 10 | 2 | 2 |
| | Dry matter(mg/l) | B. velezensis | No growth | 140 | 123 | 189 |
| | Standard deviation | LMG P-32278 | | 10 | 14 | 33 |
| MM_{nitrogen free} | Dry matter(mg/l) | No bacteria | — | — | — | — |
| | Standard deviation | | | | | |
| | Dry matter(mg/l) | B. velezensis | No growth | No growth | No growth | No growth |
| | Standard deviation | LMG P-32278 | | | | |
| | Dry matter(mg/l) | B. velezensis | No growth | No growth | No growth | No growth |
| | Standard deviation | FZB42 | | | | |
| | Dry matter(mg/l) | B. velezensis | No growth | No growth | No growth | No growth |
| | Standard deviation | LMG P-32279 | | | | |
| | | | Fungal growth in line: column culture at day 6 | | | |
| | | | | T. | Trichoderma | T. |
| | | | | harzianum | sp. MUCL | atrobrunneum |
| | | | No fungus | IHEM 5437 | 58094 | MUCL 58095 |
| MM_{casaminoacids} | Dry matter(mg/l) | No bacteria | — | 680 | 590 | 610 |
| | Standard deviation | | | 54 | 30 | 48 |
| | Dry matter(mg/l) | B. velezensis | — | No growth | No growth | No growth |
| | Standard deviation | LMG P-32276 | | | | |
| | Dry matter(mg/l) | B. velezensis | — | No growth | No growth | No growth |
| | Standard deviation | FZB42 | | | | |
| | Dry matter(mg/l) | B. velezensis | — | No growth | No growth | No growth |
| | Standard deviation | LMG P-32279 | | | | |
| MMₙᵢₜᵣₐₜₑ | Dry matter(mg/l) | No bacteria | — | 400 | 450 | 430 |
| | Standard deviation | | | 20 | 11 | 120 |
| | Dry matter(mg/l) | B. velezensis | — | 410 | 380 | 390 |
| | Standard deviation | LMG P-32278 | | 43 | 57 | 21 |
| | Dry matter(mg/l) | B. velezensis | — | 320 | 470 | 420 |
| | Standard deviation | FZB42 | | 39 | 71 | 15 |
| | Dry matter(mg/l) | B. velezensis | — | 430 | 370 | 400 |
| | Standard deviation | LMG P-32279 | | 24 | 88 | 10 |
| MMₙᵢₜᵣₐₜₑ | Dry matter(mg/l) | No bacteria | — | 410 | 390 | 415 |
| | Standard deviation | | | 18 | 21 | 38 |
| | Dry matter(mg/l) | B. velezensis | — | 430 | 425 | 395 |
| | Standard deviation | LMG P-32278 | | 2 | 34 | 17 |
| | Dry matter(mg/l) | B. velezensis | — | 390 | 430 | 400 |
| | Standard deviation | FZB42 | | 68 | 15 | 20 |
| | Dry matter(mg/l) | B. velezensis | — | 410 | 355 | 410 |
| | Standard deviation | LMG P-32278 | | 90 | 52 | 45 |
| MM_{nitrogen free} | Dry matter(mg/l) | No bacteria | — | No growth | No growth | No growth |
| | Standard deviation | | | | | |
| | Dry matter(mg/l) | B. velezensis | — | No growth | No growth | No growth |
| | Standard deviation | LMG P-32278 | | | | |
| | Dry matter(mg/l) | B. velezensis | — | No growth | No growth | No growth |
| | Standard deviation | FZB42 | | | | |
| | Dry matter(mg/l) | B. velezensis | — | No growth | No growth | No growth |
| | Standard deviation | LMG P-32279 | | | | |

Table 1 and FIGS. 1A, 1B and 1C. show the growth of Bacillus producing antifungal lipopeptides species and the growth of Trichoderma species according to different culture conditions: (A) in a Minimal Medium comprising casamino acids (casein hydrolysate) as a nitrogen organic source (MM_{casaminoacids}); (B) in a Minimal Medium comprising NaNO₃ as a nitrogen mineral source (MMₙᵢₜᵣₐₜₑ); (C) in a Minimal Medium comprising NaNO₂ as a nitrogen mineral source (MMₙᵢₜᵢᵣᵢₜₑ). On FIGS. 1A, 1B and 1C, the dry matter of T. harzianum IHEM5437, Trichoderma sp. MUCL 58094 and T. atrobrunneum MUCL 58095 in co-cultures in different MM is respectively expressed as a mean of the dry matter obtained with the different bacteria (dry matter relative to each fungus can be found in Table 1).

These results highlight that:
a composition/co-culture medium according to the disclosure comprising a bacteria of the genus Bacillus producing antifungal lipopeptides and a fungus of the genus Trichoderma cannot be obtained in the absence of a nitrogen source (see in Table 1 MM_{nitrogenfree});
when present alone (not in co-culture), bacteria of the genus Bacillus producing antifungal lipopeptides and fungi of the genus Trichoderma are able to grow in a culture medium comprising a nitrogen organic source;
a composition/co-culture medium according to the disclosure comprising a bacteria of the genus Bacillus producing antifungal lipopeptides and a fungus of the genus Trichoderma cannot be obtained if the nitrogen source is a nitrogen organic source: only the bacteria of the genus Bacillus producing antifungal lipopeptides grows and overgrows the fungus of the genus Trichoderma;
when present alone (not in co-culture), bacteria of the genus Bacillus producing antifungal lipopeptides cannot grow in a culture medium comprising a nitrogen mineral source;
a composition/co-culture medium according to the disclosure comprising a bacteria of the genus Bacillus producing antifungal lipopeptides and a fungus of the genus Trichoderma allows the growths of both the bacteria and the fungus if the nitrogen source is a nitrogen mineral source: both the bacteria and the fungus grow;
the Trichoderma strains quantities (dry matter) measured in the different co-cultures according to the disclosure or in mono-culture are equivalent, showing that a composition/co-culture medium according to the disclosure allows a normal growth of Trichoderma strains even in the presence of Bacillus strains producing antifungal lipopeptides;
Bacillus strains quantities (dry matter) are measured in the different co-cultures according to the disclosure while there is no growth of Bacillus strains in mono-culture, showing that a composition/co-culture medium according to the disclosure regulate and optimize the growth and development of Bacillus strains. In the context of the present disclosure, it has been highlighted that the bacteria grows partly attached to the fungus filaments what was determined to be favourable for the growth of the bacteria.
   2. Comparative Test: Growth of B. velezensis LMG P-32278 in a Composition/in a Co-Culture Medium According to the Disclosure Comprising NaNO₃ as a Nitrogen Mineral Source and T. harzianum IHEM5437 Versus in a Composition/in a Co-Culture Medium Only Comprising NaNO₃ as a Nitrogen Mineral Source

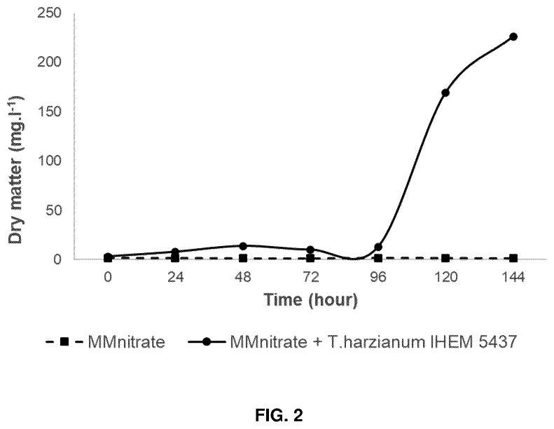

A comparative test has been performed to compare the growth of B. velezensis LMG P-32278 in a composition/in a co-culture medium according to the disclosure comprising NaNO₃ as a nitrogen mineral source and T. harzianum IHEM5437 (MMₙᵢₜᵣₐₜₑ+T. harzianum IHEM5437) versus in a composition/in a co-culture medium only comprising NaNO₃ as a nitrogen mineral source (MMₙᵢₜᵣₐₜₑ). The OD600 nm of both cultures was measured every 24 h for 6 days. The obtained results are presented in FIG. 2.

FIG. 2 shows the growth of B. velezensis LMG P-32278 (1) in a composition/in a co-culture medium according to the disclosure comprising NaNO₃ as a nitrogen mineral source and T. harzianum IHEM5437 (MMₙᵢₜᵣₐₜₑ+T. harzianum IHEM5437) and (2) in a composition/in a co-culture medium only comprising NaNO₃ as a nitrogen mineral source (MMₙᵢₜᵣₐₜₑ). As it can be seen after 90 hours, B. velezensis LMG P-32278 only grows in a composition/co-culture medium according to the disclosure, i.e. in a composition/co-culture medium comprising NaNO₃ as a nitrogen mineral source and T. harzianum IHEM5437. If the fungus T. harzianum IHEM5437 is not present, no growth of B. velezensis LMG P-32278 is observed, only the initial inoculum being detected over time. In this sense and in the context of the present disclosure, it has been unexpectedly shown that the presence of the fungus Trichoderma is favourable for the growth of the bacteria Bacillus.

3. Lipopeptide Production by B. velezensis LMG P-32278 in a Composition/in a Co-Culture Medium According to the Disclosure

The detection of antifungal lipopeptides in a 6-day old composition/co-culture medium according to the disclosure comprising NaNO₃ as a nitrogen mineral source, B. velezensis LMG P-32278 and T. harzianum IHEM5437 was performed with an ACQUITY UPLC system (Waters, Milford, MA, USA).

The sample was centrifuged and filtered through 0.2 μm cellulose filters. 10 μl of the sample was injected into an Interchim C18 column (UP5TP18-250/030 C18, Interchim, Montluçon, France). The separation and elution of lipopeptides was done at a flow rate of 0.6 ml·min⁻¹ using a gradient of solvents A and B corresponding respectively to water with 0.1% trifluoroacetic acid and acetonitrile with 0.1% trifluoroacetic acid. The gradient is as follow: from 0 to 20 min, 70% A/30% B; from 20 to 25 min, 55% A/45% B, from 25 to 30 min, 0% A/100% B; from 30 to 35 min, 70% A/30% B. In these conditions, iturins are eluted at 24 mins, fengycins at 28 mins and surfactins at 36 mins.

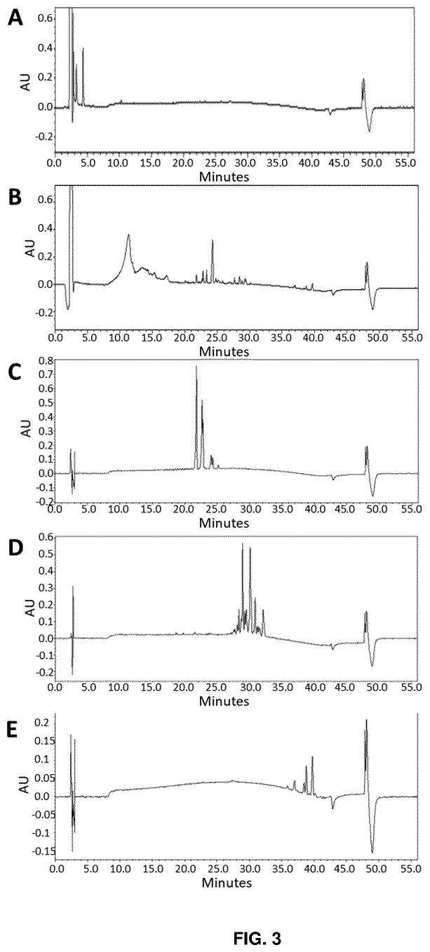

The obtained results are presented in FIG. 3 showing the UV spectrum generated by UPLC for lipopeptide detection in a composition/in a co-culture medium according to the disclosure comprising NaNO₃ as a nitrogen mineral source and both B. velezensis LMG P-32278 and T. harzianum IHEM5437 (A), compared of B. velezensis LMG P-32278 in MM_{casaminoacids} (nitrogen organic source) (B), standards of iturins (C), fengycin (D) and surfactin (E).

As it can be seen on FIG. 3A, the major lipopeptides iturins, fengycins and surfactins have not been detected in a composition/in a co-culture medium according to the disclosure, i.e. in a composition/co-culture medium comprising NaNO₃ as a nitrogen mineral source, B. velezensis LMG P-32278 and T. harzianum IHEM5437. In this sense and in the context of the present disclosure, it has been unexpectedly shown that the production of lipopeptides by the bacteria of the genus Bacillus is inhibited at least concerning the major lipopeptides. On the contrary, as it can be seen on FIG. 3B, lipopeptides iturins, fengycins and surfactins have been detected when the nitrogen source is a nitrogen organic source.

In the context of the present disclosure, in view of all the results presented and against all expectation, it has been determined that a composition/a co-culture medium according to the disclosure, i.e. a composition/co-culture medium comprising a nitrogen mineral source, allows a mutualistic relationship between at least one bacteria of the genus Bacillus producing antifungal lipopeptides and at least one fungus of the genus Trichoderma. Indeed, with a composition/a co-culture medium according to the disclosure, i.e. with a composition/co-culture medium comprising a nitrogen mineral source, it has been determined that:
the production of lipopeptides by said at least one bacteria of the genus Bacillus is inhibited/reduced (at least concerning the major lipopeptides) what is favourable for the growth of said at least one fungus of the genus Trichoderma;
the presence of the fungus is favourable for the growth of said at least one bacteria of the genus Bacillus producing antifungal lipopeptides, leading to ability of the later to grow.

### 4. Root Application Tests on Tobacco Under Nutrient-Limiting Conditions

Tobacco seeds were sown on a moist compost/sand (1:1) mixture to break dormancy (23° C.+/−1° C., 16 h/8 h photoperiod).

At the 4-leaf stage, after 2 weeks of growth, the seedlings were transplanted individually into pots containing a compost/sand mixture identical to the previous one. From this stage, the seedlings were watered regularly throughout the trial.

Two weeks later (D+28 after sowing), the plants received their first treatment by inoculation of the following solutions (1 mL) at the collar of each plant (10 repetitions per treatment modality): «control (physiological water)», «0.5 M sodium nitrate», «B. velezensis FZB42 (1·10⁸ CFU/ml)», «T. harzianum MUCL29707 (1·10⁸ CFU/ml)», «B. velezensis FZB42 (1·10⁸ CFU/ml)+T. harzianum MUCL29707 (1·10⁸ CFU/ml)», «B. velezensis FZB42 (1·10⁸ CFU/ml)+T. harzianum MUCL29707 (1·10⁸ CFU/ml)+0.5 M sodium nitrate» (composition according to the disclosure). On D+42 and D+66, the inoculation of the same treatments was repeated.

At D+90, the plants were harvested, and the fresh root biomass was measured.

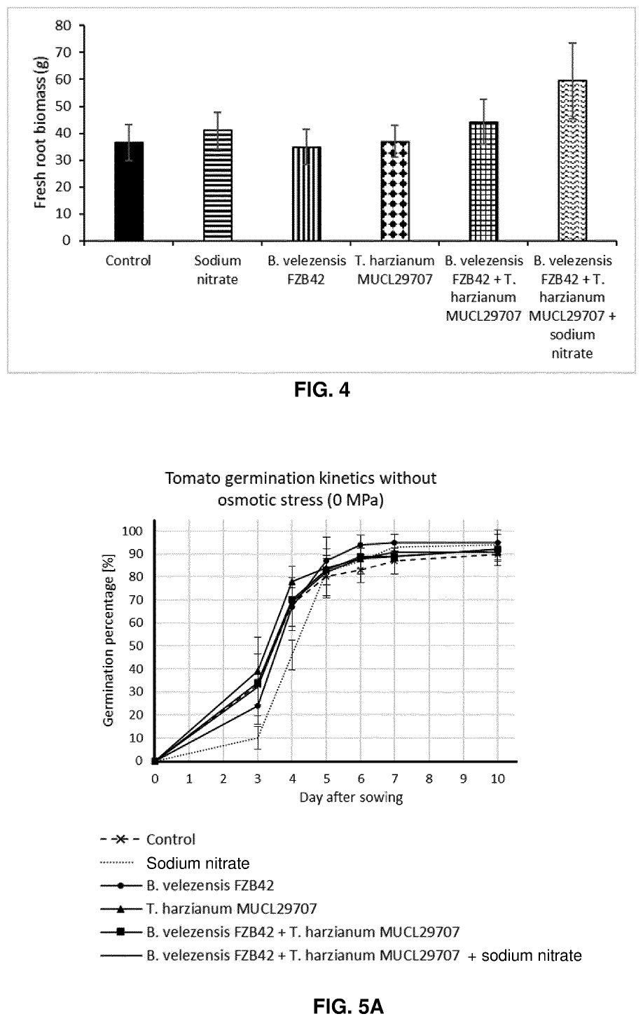

The obtained results are presented on FIG. 4. As it can be seen, the fresh root biomass obtained with the treatments «sodium nitrate», «B. velezensis FZB42», «T. harzianum MUCL29707», «B. velezensis FZB42+T. harzianum MUCL29707» was not significantly different from the biomass obtained with the «control»: the biomass values ranged from 34.7 to 44 g.

The treatment with a composition according to the disclosure («<B. velezensis FZB42+T. harzianum MUCL29707+sodium nitrate») reached a significantly higher roots production (around 60 g).

Statistical analyzes were carried out with the Minitab 19.2020.1 software. An ANOVA with one classification criterion (generalized linear model) was performed with spatial permutation of the objects during the experiment. In case of rejection of the null hypothesis of equality of the means of the various treatments, these were classified using Dunnett's test in comparison with the control.

These results confirm the efficiency of a composition according to the disclosure in stimulating roots production and consequently the growth in tobacco plants in comparison to the individual application of the microorganisms or their combination without a nitrogen mineral source.

### 5. In Vitro Germination Tests on Tomato Subjected to Water Stress Conditions

Tomato seeds were sterilized with 14% sodium hypochlorite and 96% ethanol before being rinsed thoroughly with demineralized water and then placed in Petri dishes.

Twenty seeds were placed per Petri dishes. Depending on the level of osmotic stress studied, the Whatman filters present in each of the boxes were soaked with specific solutions of PEG (Polyethylene glycol) so as to generate a water stress of 0, −0.1, −0.2 or −0.3 MPa.

The following solutions «0.5 M sodium nitrate», «B. velezensis FZB42 (1·10⁸ CFU/ml)», «T. harzianum MUCL29707 (1·10⁸ CFU/ml)», «B. velezensis FZB42 (1·10⁸ CFU/ml)+T. harzianum MUCL29707 (1·10⁸ CFU/ml)», «B. velezensis FZB42 (1·10⁸ CFU/ml)+T. harzianum MUCL29707 (1·10⁸ CFU/ml)+0.5 M sodium nitrate» (composition according to the disclosure) along with the control (physiological water) were directly inoculated on the seeds via a micropipette (5 μL/seeds). Per test, 5 repetitions per treatment modality were carried out for each level of water stress.

The Petri dishes containing the inoculated seeds were hermetically sealed and placed in a culture chamber for 10 days (23° C.+/−1ºC, 16 h/8 h photoperiod).

Daily, for 10 days, a count of germinated seeds was carried out. After 10 days, the aerial and root parts of the germinated seeds were weighed.

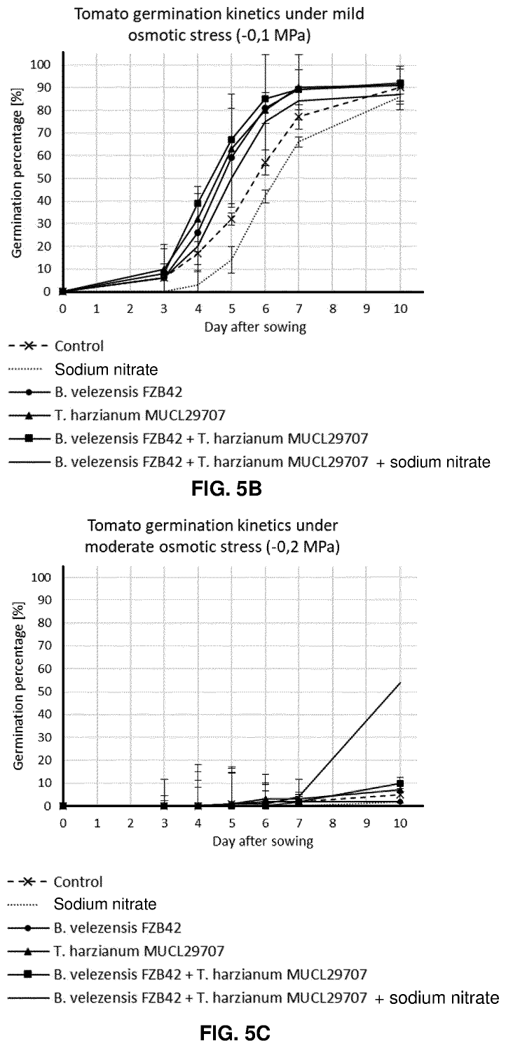

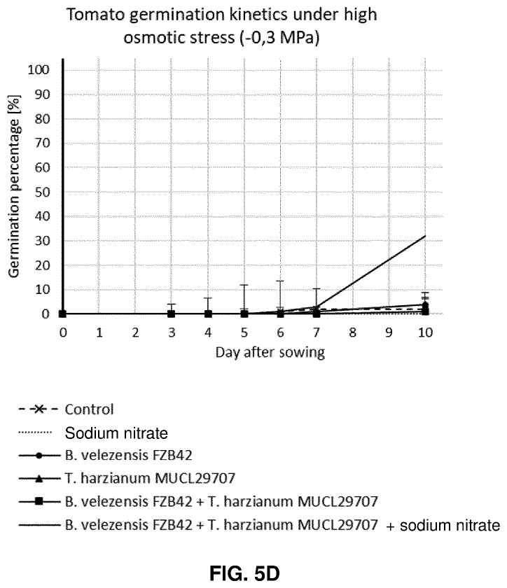

The obtained results are presented on FIGS. 5A to 5D. The germination kinetics of tomato seeds vary depending on the level of the osmotic stress. In fact, the germination kinetics are similar for all the treatments in the absence of stress or in the presence of a mild osmotic stress (see FIGS. 5A and 5B).

In the presence of moderate and high osmotic stress (see FIGS. 5C and 5D), a significant positive effect is noted with a composition according to the disclosure («B. velezensis FZB42+T. harzianum MUCL29707+sodium nitrate»). As it is shown on FIGS. 5C and 5D, only the seeds treated with a composition according to the disclosure were able to germinate in presence of an osmotic stress of −0.2 and −0.3 MPa. Around 50% and 30% of the seeds germinated after 10 days after sowing.

Statistical analyzes were carried out with the Minitab 19.2020.1 software. An ANOVA with one classification criterion (generalized linear model) was performed with spatial permutation of the objects during the experiment. In case of rejection of the null hypothesis of equality of the means of the various treatments, these were classified using Dunnett's test in comparison with the control.

These results prove that a composition according to the disclosure («B. velezensis FZB42+T. harzianum MUCL29707+sodium nitrate») helps improving the germination of tomato seeds and consequently the growth of tomato plants in the presence of a significant osmotic stress.

### 6. Lettuce Plants Protection Tests

Untreated plantlets of lettuce (Lucretia, Rijk Zwaan) were provided in four-leaf stage. These plants were sown 4 weeks earlier in peat blocks, without receiving any crop protection from that moment on. Prior to the trial, the plants were watered to maintain growth in the fitotron (14 h light at 22° C., 95% RV and 10 h dark at 18° ° C., 100% RV).

Eleven days later, the plants (30 plants per treatment) received their protecting treatment by «sodium nitrate», «B. velezensis LMG P-32279 (1·10⁸ CFU/ml)», «T. harzianum MUCL29707 (1·10⁸ CFU/ml)», «B. velezensis LMG P-32279 (1·10⁸ CFU/ml)+T. harzianum MUCL29707 (1·10⁸ CFU/ml)», «B. velezensis LMG P-32279 (1·10⁸ CFU/ml)+T. harzianum MUCL29707 (1·10⁸ CFU/ml)+0.1 M sodium nitrate» (composition according to the disclosure). The treatment was applied by spraying it over the plantlets. For each plant, 1 g of the product was used. Afterwards the products were rained off with 200 ml of water, so it could sip into the peat blocks and reach the plant roots.

One week later, the plants were infected with Rhizoctonia solani (by placing an infected grain kernel at the base of the plant). During the trial the plants were kept on a tray table where they could be efficiently watered and kept under warmer and humid conditions. The protection was evaluated one week later.

A “Rhizoctonia index” was calculated using the Townsend-Heuberger formula: (0*number of plants with Rhizoctonia at class 0+1*number of plants with Rhizoctonia at class 1+2*number of plants with Rhizoctonia at class 2+3*number of plants with Rhizoctonia at class 3+4*number of plants with Rhizoctonia at class 4)/(4*plant repetition)*100. Each class corresponds to the following criteria: class 0=no infestation; class 1=starting infestation (rusty spots on leaf vein or petiole); class 2=1-3 leaves infested, rusty spots on stem base; class 3=start of wilting, further infestation of leaves; class 4=wilting of all. High scores imply important symptoms and thereof a low protection effect of the treatment. However, low scores correspond to a higher protection against Rhizoctonia.

The obtained results are presented in the Table 2. As it can be seen, different scores of the “Rhizoctonia index” were obtained depending on the used treatment. The protection obtained with the treatments «sodium nitrate» (score 4), «B. velezensis LMG P-32279» (score 5), «T. harzianum MUCL29707» (score 5), «B. velezensis LMG P-32279+T. harzianum MUCL29707» (score 10) was lower than that obtained with the treatment with a composition according to the disclosure («B. velezensis LMG P-32279+T. harzianum MUCL29707+sodium nitrate») (score 2).

TABLE 2

| | Rhizoctonia Index |
|---|---|
| Control | 7 |
| Sodium nitrate | 4 |
| Bacillus velezensis LMG P-32279 | 5 |
| Trichoderma harzianum MUCL29707 | 5 |
| Bacillus velezensis LMG P-32279 + | 10 |
| Trichoderma harzianum MUCL29707 | |
| Bacillus velezensis LMG P-32279 + | 2 |
| Trichoderma harzianum MUCL29707 + | |
| sodium nitrate | |

These results prove that a composition according to the disclosure («B. velezensis LMG P-32279+T. harzianum MUCL29707+sodium nitrate») helps protecting plants against plant pest and plant disease. Indeed, the efficiency of a composition according to the disclosure in protecting lettuce plants against Rhizoctonia was confirmed thanks to the decrease of this pathogen impact on lettuce in comparison to the other treatments.

The present disclosure has been described in terms of specific embodiments, which are illustrative of the disclosure and not to be construed as limiting. More generally, it will be appreciated by persons skilled in the art that the present disclosure is not limited by what has been particularly shown and/or described hereinabove.

Use of the verbs “to comprise”, “to include”, “to be composed of”, or any other variant, as well as their respective conjugations, does not exclude the presence of elements other than those stated.

Use of the article “a”, “an” or “the” preceding an element does not exclude the presence of a plurality of such elements.

1. A composition for promoting plants growth and/or for protecting plants against at least one plant pest and/or one plant disease, the composition comprising at least one bacteria of the genus Bacillus producing antifungal lipopeptides, at least one fungus of the genus Trichoderma, and at least one nitrogen mineral source.

2. The composition according to claim 1, wherein the at least one nitrogen mineral source is chosen from a group comprising nitrates, nitrites, and mixtures thereof.

3. The composition according to claim 2, wherein the nitrates are chosen from a group comprising sodium nitrate, calcium nitrate, potassium nitrate, and mixtures thereof.

4. The composition according to claim 2, wherein the nitrites are chosen from a group comprising sodium nitrite, calcium nitrite, potassium nitrite, and mixtures thereof.

5. The composition according to any of preceding claim 1, wherein the composition is a form of granules, tablets, powders, liquids, emulsions, nano-formulations, encapsulates, concentrates, suspensions, dispersions, wettable granulates and powders or aerosols.

6. A method for obtaining a composition for promoting plants growth and/or for protecting plants against at least one plant pest and/or one plant disease comprising:
forming a co-culture medium, in particular a liquid co-culture medium, comprising at least one nitrogen mineral source, for example nitrates and/or nitrites, in particular nitrates and/or nitrites chosen from a group comprising sodium nitrate, calcium nitrate, potassium nitrate, sodium nitrite, calcium nitrite, potassium nitrite, and mixtures thereof; and
adding to the co-culture medium at least one bacteria of the genus Bacillus producing antifungal lipopeptides and at least one fungus of the genus Trichoderma, for example lyophilised or dried cells of at least one bacteria of the genus Bacillus producing antifungal lipopeptides and lyophilised or dried spores of at least one fungus of the genus Trichoderma.

7. A use of a composition according to any claim 1 to promote plants growth and/or to protect plants against at least one plant pest and/or one plant disease, in agricultural and horticultural applications.

8. The use according to claim 7, wherein the composition is applied before harvest or post-harvest to the whole plant, the rhizosphere, the roots, the leaves, the flowers, fruits, seeds, seedlings or seedlings pricking out, propagation material such as tubers or rhizomes, and/or to the soil or inert substrate wherein the plant is growing or in which it is desired to grow, by spraying, drenching, soaking, dipping, injection or administration through fertilizing or irrigation systems.

9. The use according to claim 7, wherein the plant pests include at least one of fungi, oomycetes, bacteria, viruses, viroids, virus-like organisms, phytoplasmas, protists, protozoa, nematodes, and insects.

10. A method for promoting plants growth and/or for protecting plants against at least one plant pest and/or one plant disease, the method comprising:
applying an effective and substantially non-phytotoxic amount of the composition according to claim 1 to at least one of a part of a plant; and
obtaining protection of the plant against at least one plant pest and/or plant disease, in particular against at least one plant pest selected from the group comprising fungi, oomycetes, bacteria, viruses, viroids, virus-like organisms, phytoplasmas, protists, protozoa, nematodes, and insects and/or obtaining growth promotion of the plant.

11. The method according to claim 10, wherein the composition is applied before harvest or post-harvest to the whole plant, the rhizosphere, the roots, the leaves, the flowers, fruits, seeds, seedlings or seedlings pricking out, propagation material such as tubers or rhizomes, and/or to the soil or inert substrate wherein the plant is growing or in which it is desired to grow, by spraying, drenching, soaking, dipping, injection or administration through fertilizing or irrigation systems.

12. A co-culture medium for producing at least in part a composition according to claim 1, comprising simultaneously at least one bacteria of the genus Bacillus producing antifungal lipopeptides, and at least one fungus of the genus Trichoderma, the co-culture medium comprising at least one nitrogen mineral source.

13. The co-culture medium according to claim 12, wherein the at least one nitrogen mineral source is chosen from a group comprising nitrates, nitrites, and mixtures thereof.

14. The co-culture medium according to claim 13, wherein the nitrates are chosen from a group comprising sodium nitrate, calcium nitrate, potassium nitrate, and mixtures thereof.

15. The co-culture medium according to claim 13, wherein the nitrites are chosen from a group comprising sodium nitrite, calcium nitrite, potassium nitrite, and mixtures thereof.
